(19) United States
(12) Patent Application Publication
(10) Pub. No.: US 2007/0143676 A1
(43) Pub. Date: Jun. 21, 2007

(54) Electronic map with a drawing feature

(75) Inventor: Shu-Ching Chen, Changhua City (TW)

Correspondence Address: COOPER & DUNHAM, LLP, 1185 AVENUE OF THE AMERICAS, NEW YORK, NY, 10036, US

(73) Assignee: Taiwan Online Co., Ltd.

(21) Appl. No.: 11/312,261

(22) Filed: Dec. 20, 2005

(51) Int. Cl. G06F 3/00; G01C 21/32; G08G 1/123

(52) U.S. Cl. 715/700; 340/995.1; 701/208

(57) ABSTRACT

An electronic map with a drawing feature is provided by the invention that allows user to border an area or depict a route as a graphic drawing line on the electronic map directly and make relationship between the drawing and the electronic map, whereby the drawing will be zoomed in and out to fit with current scale of the electronic map and provide the real estate company an aid in deploying and assigning the business region.

### BACKGROUND OF THE INVENTION

1. Field of the Invention

The present invention relates to an electronic map, and more particularly to an electronic map with a drawing feature where the drawing objects on the electronic map can be zoomed in and out to fit with a current scale of the electronic map.

2. Description of Related Art

As the development of electronic technology, many people use a electronic maps to print out destinations before they travel, so an electronic map has been regarded as a useful tool for looking for certain locations nowadays. A conventional electronic map comprises multiple digital images converted from paper map images or drafted by computer programs. With increase of demands, electronic maps offer additional functions, such as to provide specific symbols to parts of the famous shop or scenic spots of historical significance in the map to make a user searching a specific locations easily and conveniently.

However, the usage of a electronic map is still an inconvenience, a electronic map provided zoom in and out feature that allow user to get main arteries by zooming-out the map and get detail geographic location by zooming-in the map, but it is difficult to find a specific location in the zooming-in map by shifting the map with mouse.

Furthermore, mostly electronic maps have not offered network information of businesses. The network transaction was adopted because the Internet applications are more popular, a consumer obtains the Info of a business by accessing the web site via network and even makes a consumption immediately.

To overcome the shortcomings, the present invention provides an electronic map with a drawing feature to obviate or mitigate the aforementioned problems.

### SUMMARY OF THE INVENTION

The main objective of the present invention is to provide an electronic map with a drawing feature that allows users to depict the traveling route or draw a border on the electronic map and the size of the drawing will automatically fit with the current scale of the electronic map.

Other objectives, advantages and novel features of the invention will become more apparent from the following detailed description when taken in conjunction with the accompanying drawings.

### BRIEF DESCRIPTION OF THE DRAWINGS

FIG. 1 is a schematic diagram of an electronic map in accordance with the present invention;

FIG. 2 is an operational schematic diagram of the electronic map in FIG. 1 showing that the display of the drawing feature is actuated; and

FIG. 3 is an enlarged diagram of the electronic map in FIG. 2.

### DETAILED DESCRIPTION OF THE PREFERRED EMBODIMENT

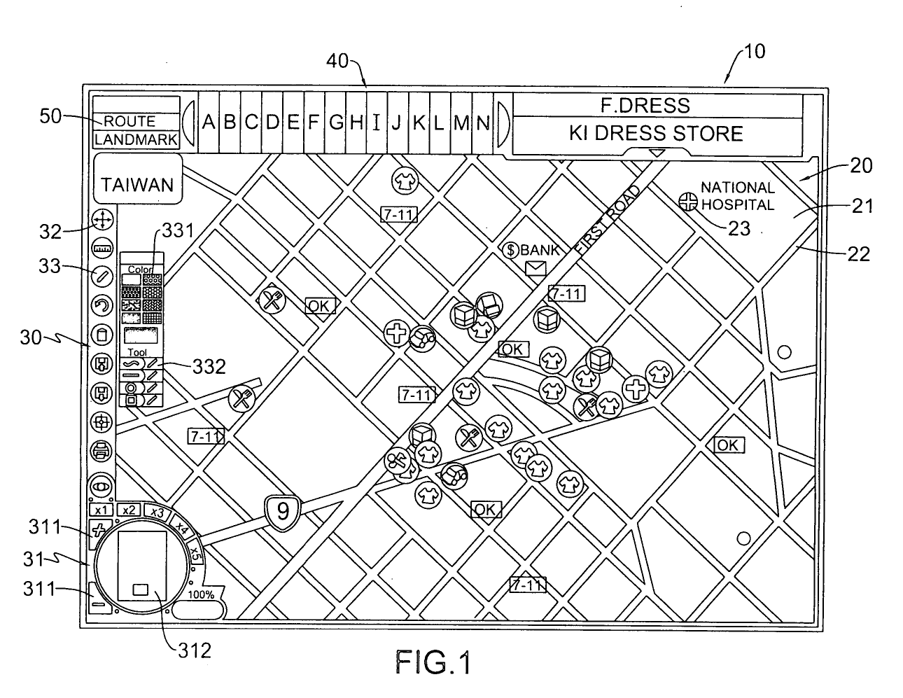

With reference to FIGS. 1, an electronic map in accordance with the present invention comprises a graphic map, defining means, grouping means, displaying means and shifting means and drawing means.

The graphic map (20) comprises multiple digital landform objects (21), digital route objects (22) and digital landmark objects (23).

The defining means is defining the digital landform objects (21), digital route objects (22) and digital landmark objects (23) to individual objects, respectively.

The grouping means is dividing the digital route object (22) into national road, provincial road or local road in Road Bar (30) according to the characters of digital route object (22) and dividing the digital landmark objects (23) into Food, Clothing, Housing, Transportation, Education or Entertainment in Landmark Bar (40) according to the characters of digital landmark objects (23);

The displaying means is establishing relative coordinate relationship between digital landform object (21) digital route objects (22) and digital landmark objects (23) on the graphic map (20);

The shifting means is zooming in or out from the center point of the map currently displayed by actuating the plus (+) key and the minus (−) key (311) in a Tool Bar (30), showing all existing zones on the map by actuating show all (312) in the Tool Bar (30), panning left, right, up and down the map by actuating the arrow key in the Tool Bar (30).

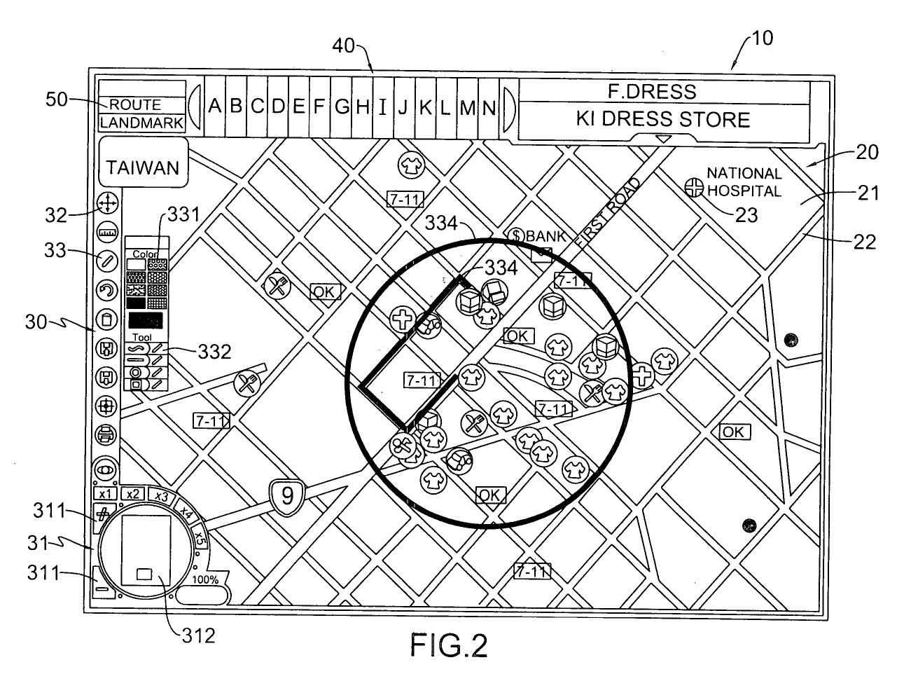

With reference to FIGS. 2, the drawing means is bordering an area and depicting a route line as a graphic drawing on the graphic map (20) by selecting desired pan color in color menu (331) and desired line shape in tool menu (332);

symbolizing the graphic drawing into digital drawing object (334); and

displaying the graphic map (20) with the graphic drawing by establishing relative coordinate relationship of the digital drawing object (334) on the digital map (21).

Whereby the movement of the drawing and the size of the drawing drawn on the graphic map (20) will be fit with a current scale of graphic map (20).

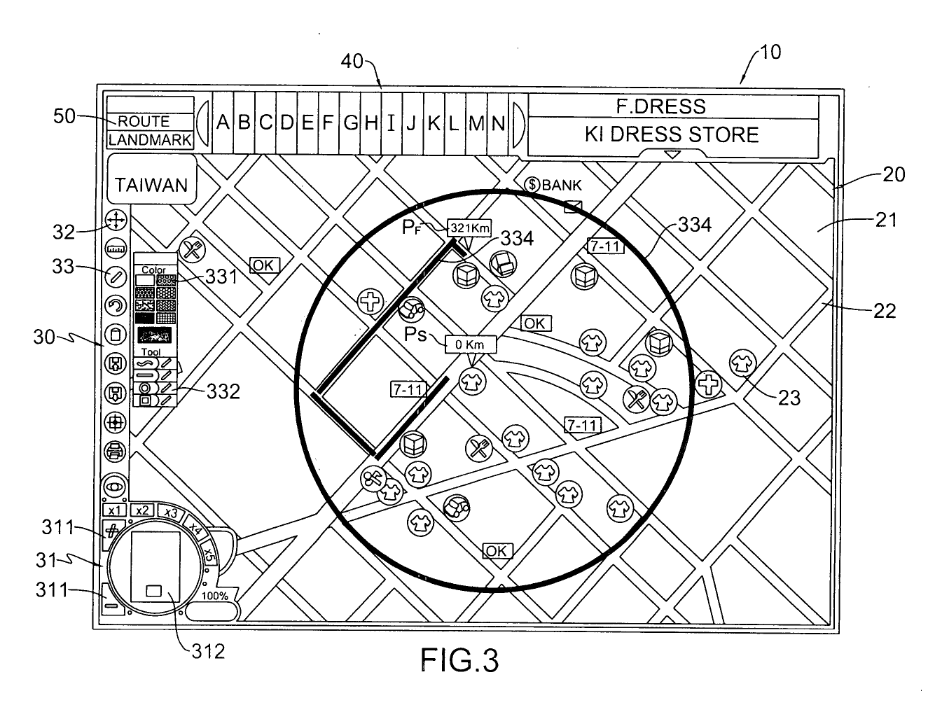

With reference to FIG. 3, the Electronic map further comprises distance measuring means for setting a first point Pₛ referring to an digital landform object (21) and a second point P_{F} referring to an digital landform object (21) and popping up a tip to show the distance between the two points that assist user in making the proper deployment and assignment as well as planning optimal route.

Even though numerous characteristics and advantages of the present invention have been set forth in the foregoing description together with details of the structure and function of the invention, the disclosure is illustrative only. Changes may be made in detail especially in matters of shape, size, and arrangement of parts within the principles of the invention to the full extent indicated by the broad general meaning of the terms in which the appended claims are expressed.

What is claimed is:

1. In an electronic map comprising
a graphic map comprising multiple digital landform objects and digital route objects;
defining means for defining the digital landform objects and the digital route objects to individual objects, respectively;
displaying means for establishing relative coordinate relationship between the drafted object, the digital landform objects and the digital route objects on the graphic map; and
drawing means for draw a graphic object on the graphic map and defining the drafted graphic object to be an individual object on the graphic map.

2. The electronic map as claimed in claim 1, wherein the graphic map further comprises multiple digital landmark objects; and
the defining means for defining the digital landmark objects to individual objects, respectively.

3. The electronic map as claimed in claim 2 further comprising route grouping means for grouping the digital route objects into multiple route layers according to characters of the digital route objects.

4. The electronic map as claimed in claim 3 further comprising landform grouping means for grouping the digital landform objects into multiple landform layers according to characters of the digital landform objects.

5. The electronic map as claimed in claim 4 further comprising landmark grouping means for grouping the digital landmark objects into multiple landmark layers according to characters of the digital landmark objects.

6. The electronic map as claimed in claim 5, wherein:
the drawing means comprises a color menu for a user selecting a desired color in color menu and a tool menu for the user selecting a desired line shape in tool menu.

7. The electronic map as claimed in claim 1 further comprises distance measuring means for setting a first point Ps referring to an digital landform object and a second point P_{F} referred to an digital landform object and popping up a tip to show the distance between the two points.
